(19) United States
(12) Patent Application Publication
(10) Pub. No.: US 2010/0127896 A1
(43) Pub. Date: May 27, 2010

(54) Optical path alignment landing system

(76) Inventor: Bland Hugh Schwarting, San Antonio, TX (US)

Correspondence Address: Bland Hugh Schwarting, 524 Alta Avenue, San Antonio, TX, 78209, US

(21) Appl. No.: 12/313,495

(22) Filed: Nov. 21, 2008

(51) Int. Cl. G01C 21/00

(52) U.S. Cl. 340/972

(57) ABSTRACT

This invention involves the hardware and system for aiding a pilot in maintaining the desired approach path on VFR during the landing procedure. It is an on-board device comprised of analog parts. Approach path indicator lights or other clues from the ground or air are not necessary. The only requirement is that the pilot see the runway. He can choose and set his own aiming point. The landing by OPAL requires very little, if any, reference to the cockpit's instrument panel. The throttle and control surfaces should be functioning properly. Lights from the pilot's spectacle frame are reflected from a (clear, gravity oriented, pendular, magnetically stabilized) plastic plate to the pilot's eyes. These images are then mentally projected (superimposed) through said plate to the runway at a constant angle. OPAL maintains this angle (approach path) regardless of the attitude of the aircraft. The pilot, by flying, places the lights on the aiming point.

### BACKGROUND

When airplanes were smaller and slower than they are today the need for visual landing aids VFR was not a major problem. Runway border lights were used for night landings. Later, the momentum of larger and faster aircraft necessitated the development of visual landing aids to prevent overrun or undershooting of the runway. These systems differ so greatly from the unique OPAL that their descriptions are not extensive:

ALS: This is a system to aid pilots during the transition zone from IFR to VFR. A configuration of lights extends from the runway as far as 3000′ into the approach area. It consists of a multitude of lights.

VASI: Visual Approach Slope Indicator . . . . This system includes not only VASI itself but also other systems known as PAPI, Tricolor VASI, Pulsating VASI, T-VASI and Alignment of Elements Systems.

Each of the above is based on a system that involves lights and/or structures which originate from the ground near the area of the runway. These systems passively offer visual information to the pilot regarding the approach path. They have many factors in common yet there are great differences in the number and arrangements of the lights. Most are color coded. They also vary in the number and arrangement of bars of lights. The Tricolor VASI uses only one light but with 3 colors. Another VASI system utilizes 16 lights (eight on each side of the runway). Most systems have a code represented by a confusing arrangement of varying numbers of red and white lights in a more confusing arrangement of varying numbers of bars of lights. OPAL provides a very simple yet very reliable system which can be easily used to fly the selected approach path. OPAL projects (superimposes) reflected images to the runway area to become the approach path. These lights originate in the cockpit, are reflected in the cockpit, and are projected from the cockpit, the details of which are described in SPECIFICATION/CLAIMS. If the pilot can see the runway from any distance, day or night (in the final approach direction) he can begin to use OPAL to fly, e.g. a 3° landing path. Distance does not dim the lights of OPAL. OPAL can be considered a universal approach path system being able to cast it's own path onto runways with or without approach path systems. OPAL, by originating in the cockpit, can set it's own aiming point on a runway. Small, medium and large aircraft can utilize OPAL effectively. It is truly a portable approach path system which, by pilot control, places and holds (simultaneously) both aiming point and approach path at the desired “spot” on the runway.

FIELD OF SEARCH: The following U.S. patents, among others, were gleaned for related information: U.S. Pat. Nos. 3,964,015, 7,088,263, 5,311,194, 7,085,630, 6,157,876, 6,239,745, 6,239,745, 5,823,479, 5,745,054, 5,702,070, and D269125. There has existed a device D269125 which incorporated batteries and light bulbs in the temples of a spectacle frame to illuminate reading material in the dark. For convenience OPAL locates the light sources below the temples of a spectacle frame but makes no claims to that in OPAL, see Claim #3, p.9. The claim #3 is for a specific location of the lights only, not that they are attached to a spectacle frame. It is this specific location which steadies the important reflected beam vertically. Reflector gunsights which were used on early W.W.II P-40s and Spitfires were fixed to the plane, moving as the attitude (pitch) of the aircraft changed. OPAL is, by necessity, gravity oriented to the earth, not moving with the change of vertical pitch of the plane. The gunsights did incorporate and OPAL does incorporate the “reflect and project” principle. The reflection concerning OPAL, however, is from a pendular plate, oriented to the earth not the aircraft. The reflector plate of OPAL functions independently of the aircraft., “holding fast” the vertical approach angle.

### SUMMARY

In search for a simpler solution to the problems associated with various devices used today for “approach path indicators” on VFR, the unique system of OPAL was created. The category of OPAL is 244 Aeronautics, Subclass Fixed Wing Aircraft. The invention is based on the natural forces of gravity and magnetism using only analog parts. The approach path originates from lights at the sides of the pilot's head. Pencils of these lights are then reflected by a gravity oriented, magnetically stabilized, hanging (pendular) clear plastic plate to the pilot's eyes. The light images are then projected through (superimposed) the same plastic plate to the area of the runway where they become the approach path. The pilot can select the aiming point. OPAL does not require information from the ground or air. OPAL's only requirement is that the pilot see the runway. OPAL's universality of use is one of its greatest assets. It provides the approach path for landings involving short or long runways and those with or without approach systems. Large or small aircraft can utilize OPAL in a variety of routine or emergency situations. It can cast it's approach path onto any prospective landing surface from a gravel strip to a long sophisticated runway. In a sense it is a portable approach path and one which can allay anxiety by using only the one system for any runway. Skill and thus safety would likely be improved. The path (angle) can be seen in the clouds if or when on IFR. OPAL then is ready for immediate use (without searching) in the transition phase. The instant the runway is visible the lights of OPAL indicate that the aircraft is high, low, or on the approach path. The pilot can then make needed corrections and fly the aircraft to touchdown.

### DESCRIPTION OF DRAWINGS (TOTAL 13 FIGS)

FIG. 1 PLATE Side view of the main PLATE with it's attachments. By being tilted 3° the reflection of the lights will also be 3° * Plain bearings are fixed by housing to the aircraft

FIG. 2 BALL Also a side view, BALL is fixed (snap locked) at the position as shown in the drawing.

FIG. 3 PLATE An angled view of PLATE from the front with side and top edges shown.

FIG. 4, 5, 6 BEAM Comprised of 3 drawings, (hardware) FIG. 4 Frame A side view showing the light source. FIG. 5 Schematic (electrical) FIG. 6 Switch When donning frames lights turn on.

FIG. 7, 8 PITCH Comprised of 2 drawings FIG. 7 Level This is attached to the real aircraft so that the aircraft drawing is aligned with the real craft FIG. 8 Simulation Shows the pilot monitoring the aircraft's pitch or attitude, adjustable mirror fixed to aircraft

FIG. 9, 10 11 BEAM—PATHS Comprised of 3 drawings: FIG. 9 The light paths are viewed from above as they clear the side of pilot's head and are reflected to the eyes for projection. See “Projection of Images” below FIG. 10 View from the side shows that all paths are in the same plane (geometric). This plane is 90 degrees from that of the Plate and 3 degrees from the horizontal. FIG. 11 This view from the pilot's eyes shows the two lights being kept (same level) on an aiming point. The wheels, being lower than the pilot's eyes, will touch down closer to the 35 runway marker than an aiming point whether the point is real (a physical marker) or chosen by the pilot

FIG. 12 FLAT vs CURVED PLATE Shows the distance between the 2 lights being closer with a horizontally curved plate

FIG. 13 BEAM (alternate) Shows adjustable fore and aft light unit, see also claim 3c, p. 9.

### PROJECTION OF IMAGES

Beside the 3° vertical projection each light image is also projected at an estimated 1° temporally from the ipsilateral (same side) eye. This measurement varies significantly but 1 degree is estimated to be the average lateral projection of each light image from the runway. At a distance of 1 mile from the runway each light image appears laterally 57′ relative to the runway border, see RELEVANT MATH below. At a distance of 3000′ each image is at or near threshold (150′ wide) border. The pilot keeps the aiming point level with the images which appear to move closer to the runway as the craft approaches the threshold. At 1000′ away, FIG. 11, the images appear inside the width of the threshold. The closer the images move to each other and to the aiming point the more accurate the flight path becomes. The pilot has the option of selecting the aiming point depending on the size of the aircraft. Larger aircraft require aiming points farther from threshold than the smaller planes.

RELEVANT MATH Flat Plate, horizontal (to the side) projection, one image:

1 degree=approximately 1/40 ratio . . . or horizontal (side) projection each image/distance of landing craft from threshold

1 Mile×5280′×1° ratio (1/40)=132′−75′ (½ of 150′ wide runway)=57′

3000′×1° ratio (1/40)=75′ (border line of 150′ wide runway)

The horizontal (to the side) projection of angles above are not only estimated but also vary with the distance of the PLATE from the pilot's eyes. A plate distance of 22″ puts the images closer together than a distance of 18″ and vice versa. Also a mild curve around the vertical axis (convex side toward pilot) of the PLATE can result in a very signicant narrowing of the distance between the images. Narrowing of the images increases the accuracy of OPAL. An alternate model of the PLATE with said curve will be made, see NOTES page 20, par. 0028. In case the vision in one eye was lost in flight both images would still be seen with the good eye. The temporal projection of the image on the “blind eye side” would increase only slightly with the curved PLATE.

Notes: Continuing studies:

Study 1 Regards the mild curving of the plate around the vertical axis (convex surface towards the pilot). Noted is that this mild curve would not cause discernible distortion (vertical or horizontal) of the view through the PLATE just as the view through a curved car windshield results in no noticeable distortion. The horizontal curve of the PLATE does, however, alter the horizontal reflection from the plate which results in a narrowing of the distance between the projected images without changing the vertical angles (approach path). With only a mild curve of the PLATE the distance between the projection of the light images can be decreased by 33% which would increase the accuracy of alignment particularly at farther distances from the runway.

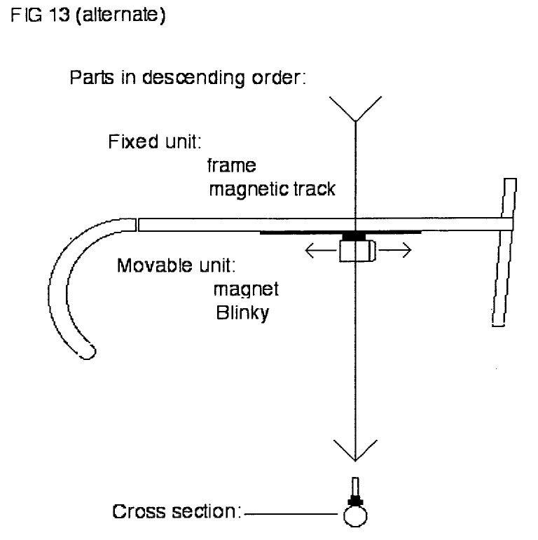

Study 2 Involves the making of the lights of BEAM to also be adjustable fore and aft which would allow settings for individual pilots, see FIG. 13 BEAM (alternate). The demonstration model has been so altered.

Study 3 Regards counteracting the forces of acceleration/deceleration on the PLATE without resorting to a gyroscope. These forces can be satisfactorily controlled by “flying.” Since more throttle and more “up elevator” have opposite effects on airspeed, this combination should be used, proportionally, to control airspeed when elevating the aircraft to the approach path. The opposite control combination is used to lower the aircraft. Pitch should not exceed the near level. There is a point in all VFR landings when “flying the path” is done and the pilot uses his skill until touchdown. This point varies as to distance from threshold and to aircraft size. Pilot experience is always a valuable asset.

### Specification/Claims:

PART 1 MODEL: A functioning demonstration model of OPAL has been made which is referred to in describing the 6 parts of the invention. The sizes and shapes of the physical parts are approximate and are for demonstration only. The METHOD of use unfolds gradually as the parts are described. The descriptions are in the present tense. The relationship of parts to methods is described in more detail in PART 6 METHOD.

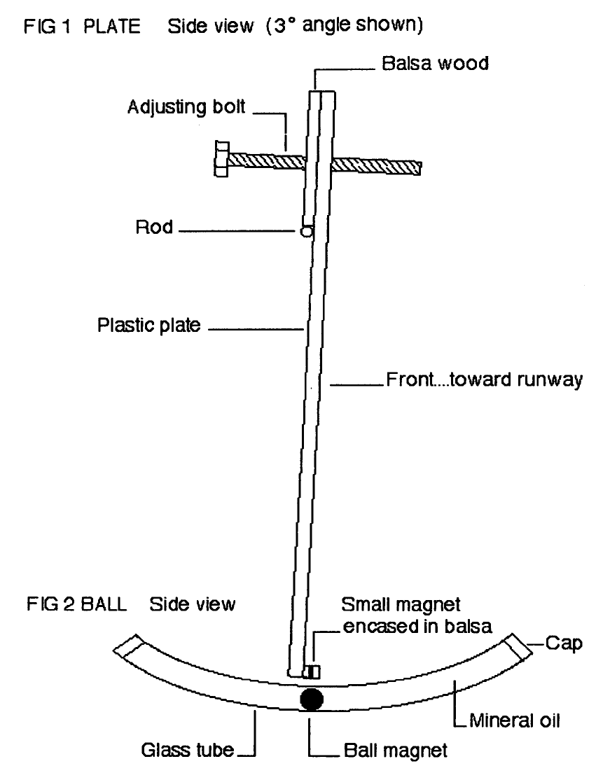

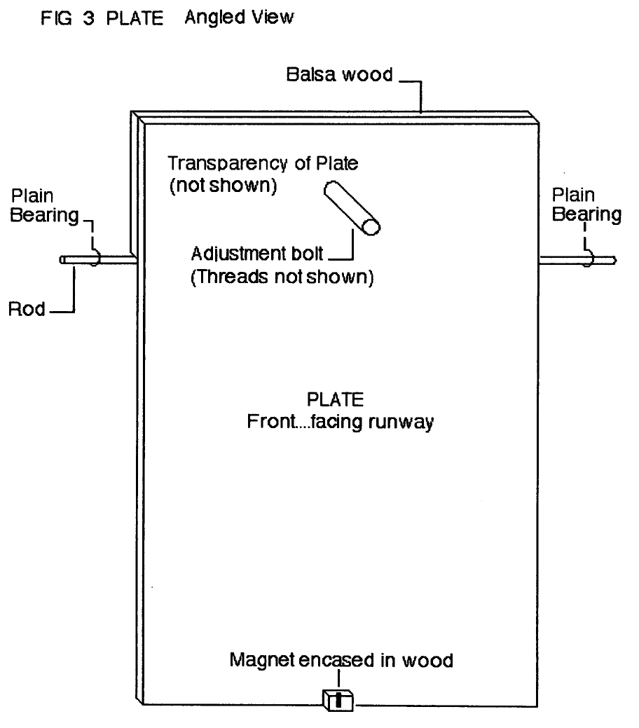

PART 2 PLATE: FIG. 1 and FIG. 3. These show a rectangular flat, or mildly curved (see NOTES p. 20) plate of clear acrylic plastic which measures 8″×6″×⅛″. The PLATE is true to specular reflection and transmission of light. It includes smaller parts. A round ⅛″ in diameter hard metal rod is glued across one surface of PLATE which divides the PLATE into a horizontal rectangle 6″×2″ above and a 6″ square below. The side with the rod is the back of the PLATE and the square of this division is the bottom of the PLATE. The rod extends 1½″ from each side of the PLATE. A piece of balsa wood approx. 6″×2″×⅛″ is glued to the top of the rod and the top remaining back of the PLATE. A metal bolt is screwed through the middle of the wood and plastic from back to front. At the bottom midpoint of the front of the PLATE, encased in balsa wood, is a very small ytterbium magnet.

PART 3 BALL: FIG. 2. This is a curved 5½″ glass tube with an inside diameter of ½″. The middle of the outside most concave curve of the tube is placed straight up vertically in line with the bottom middle of the PLATE and 90 degrees to the plane of the PLATE. The radius of the pendular “swing” of the PLATE, measured from the rod, is 6″. The radius of the most concave curve of the tube is 6¼.″ The difference between the two lengths of radii or swings of arc is ¼″. The tube is filled with mineral oil and a ⅜″ ytterbium ball magnet and is closed at each end.

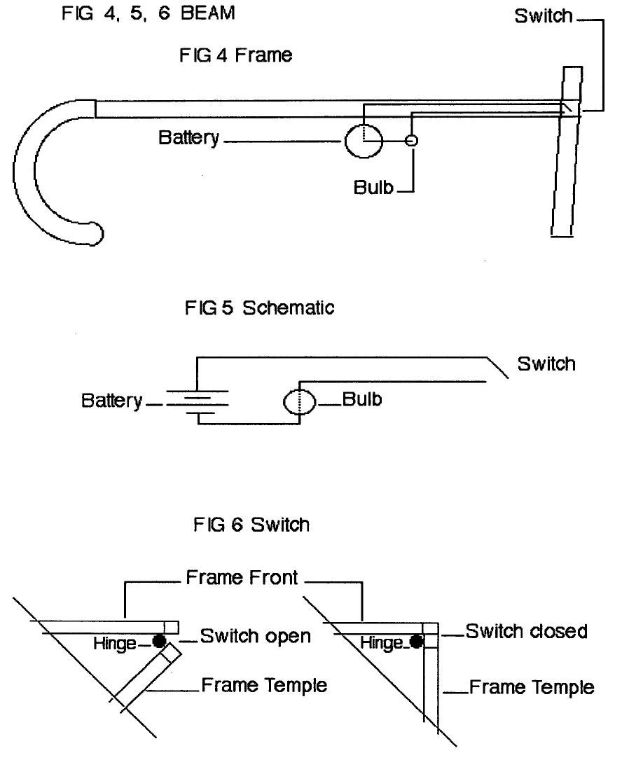

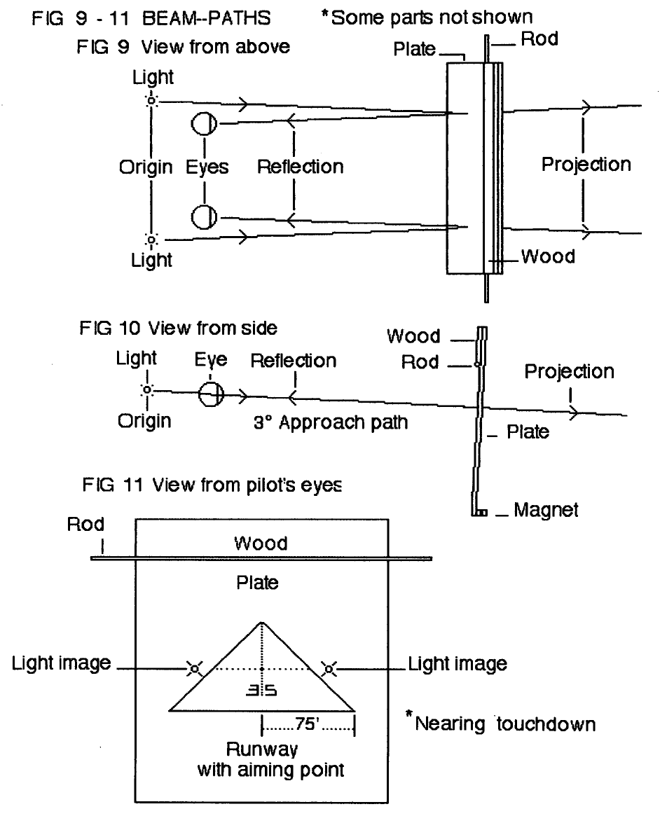

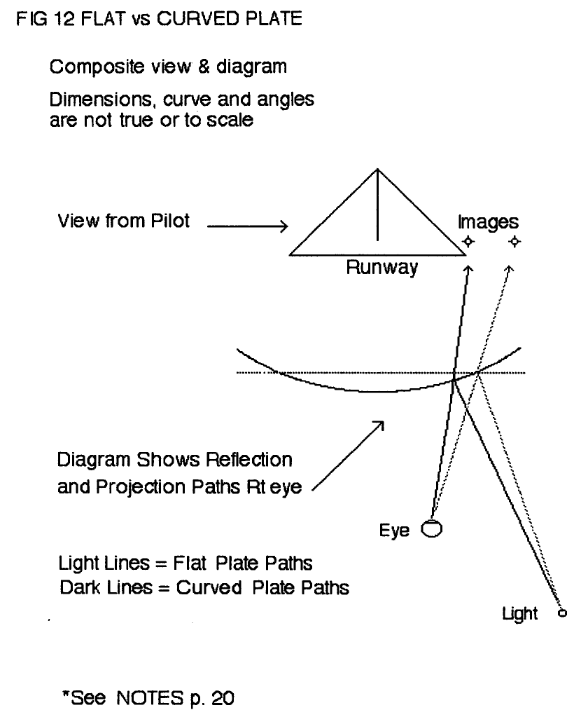

PART 4 BEAM: This refers to the location of the light sources of the invention not to how this location is attained. In the demonstration model a tiny battery with a tiny light is attached to the lower portion of each temple of a spectacle frame, FIG. 4. Firstly, this location should be close to the pilot's temple (sideways) but not so close as to block the pencils of light which are reflected to the pilot's eyes from the PLATE, FIG. 9. There are switches in the hinges of the frames so that when the temples are opened, as in donning the frames (with or without corrective lenses) the switches are closed and the lights “turn on,” FIG. 6. Secondly, the lights should be approximately at eye level vertically (up and down) with the pilot's head in it's usual flying position, FIG. 10. Thirdly, the location front and back (fore and aft) should be such that if the wearer (pilot) tilted his head forward or backward (a motion of agreement) while looking squarely into a flat wall mirror at approximately 20″ there would be no (or insignificant) vertical movement of the reflected images of the lights as compared to objects on an opposing wall 10′ or more straight behind him. The use of a spectacle frame is not essential but it is a very good method to describe OPAL and is used in the demonstration model. Any device, (which has tiny batteries and lights, LEDs, fiber optics, Blinkies, or others) which satisfies the size, shape, brightness and location of lights is also acceptable. Claim #3 of the invention defines the location of the lights. An approximate location fore and aft is at the little depression (which can be felt with a forefinger) at the inside of the acute angle formed by the junction of the posterior border of the orbital rim with the superior border of the zygomatic arch (of the pilot's head). Adjustable or customized hardware is necessary in order to position the lights for individual pilots and such has been made, see FIG. 13,

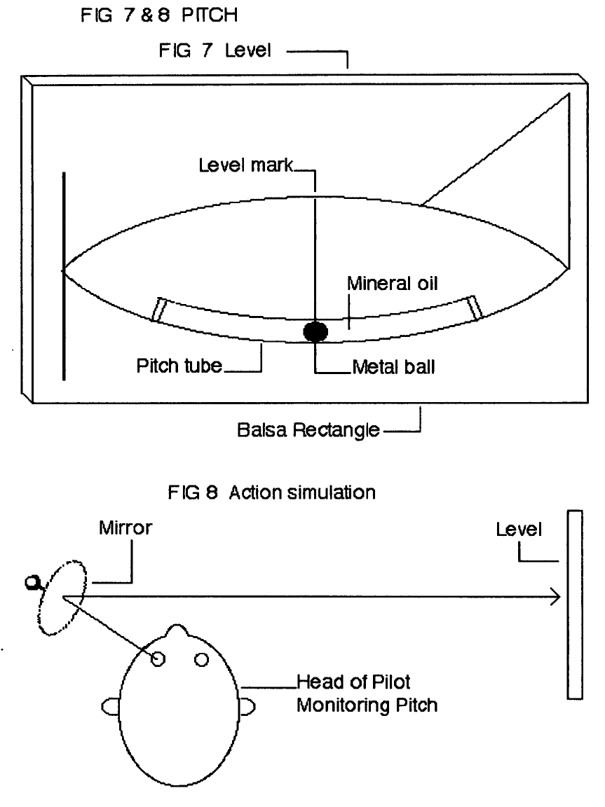

PART 5 PITCH: This is comprised of two parts. First, a rectangular piece of balsa wood 7″×4″×½″ (FIG. 7 Level) is attached to the cockpit up and forward of the pilot's rt. eye. A simple cartoon-like drawing of a plane is placed on the wood so that it appears to be flying level and in the same direction as the real plane. The shape of the pictured plane is oval with a point at the nose and the tail. A vertical “level” line is placed halfway between the nose and tail of the pictured plane. A cutout of the wood and picture is made along the lower border of the picture. This cutout (hole) is curved and the lower convex curve of it matches the lower border of the “oval shaped plane.” A 5″ curved glass tube, Pitch tube, with an ID of ½″ is fitted to the cutout. This tube is filled with mineral oil and a ⅜″ polished (to lessen friction) nonmagnetic metal ball and closed at each end. The attachment of this combined rectangle to the cockpit is important. This wood piece is placed parallel to or in the sagittal plane of the body of the real aircraft. It is positioned so that the pictured plane is level (ball on the level line) when the real aircraft is level, e.g. when on a level tarmac. With “tail draggers” refer to the schematic. On the Pitch tube smaller lines or ball widths can indicate different degrees of pitch. The ball is regarded as weight, so ball forward=nose down pitch and ball backward=nose up. The rear part of the tube can be colored with varying tones of pink or red as a stall caution or danger signal. The second part of PITCH is a simulated view, FIG. 8, of the pilot monitoring the pitch of the plane by glancing at an adjustable mirror attached to the plane's body. The reflected image shows the attitude of the aircraft from Level.

PART 6 METHOD: This shows the relationship of parts to each other and to methods used during the landing process. The housing hardware which fixes the PLATE and BALL into different positions is not a part of this invention. The PLATE with the BALL in the plane of the PLATE is moved from a storage position to a frontal position 16″-22″ before the pilot's eyes so that the pilot can view the reflection of the BEAM and also see the runway through the PLATE. The BALL is then switched from being in the plane of the PLATE to a position 90 degrees to it, FIG. 2. This move should firmly fit (snap lock) BALL in it's 90 degree position. The magnet of PLATE and the magnet of BALL interact with each other to steady the PLATE by dampening oscillation. The periods of oscillation of the BALL and PLATE are different. This difference is effective in not only stabilizing oscillation but in minimizing the effects of turbulent weather and acceleration/deceleration, see NOTES, par. 0030. The rod, being on the back of the PLATE, tilts the PLATE. The direction of tilt favors an approach angle, (bottom of PLATE toward the pilot). Weighting at the bottom of PLATE brings the angle to be 3°. To function as proposed the PLATE should maintain a pendular angle, e.g. 3° before and after placement of the small magnet of the PLATE. This magnet should therefore be placed in a plumb line from the rod, see FIG. 1 and FIG. 2. The BEAM is reflected from PLATE to the pilot's eyes to be visually projected to the area of the runway, said projection to be the approach path angle, FIG. 10. The bolt of the PLATE is for finer adjustment of the pendular angle of PLATE. Screwing the bolt forward increases the angle and vice versa. When first engaging the approach area or before a transition zone, the pilot puts the BEAM (spectacle frame) on his face thus closing the switches in the hinges of the frame, FIG. 6, thereby “turning on” the tiny lights. Each light emits a cone of light toward the PLATE. Pencils of said lights are then reflected from the PLATE to the eyes, FIG. 9 and FIG. 10. These two light images are then projected visually through the plate to the area of the runway where the lights and the runway are seen simultaneously. The PLATE had been set to hang, e.g. 3° from the vertical, the lower edge of the PLATE being closer to the pilot. The reflection of the lights of BEAM will therefore be at 3° from the horizontal, the higher part of this angle being towards the pilot. NOTE: OPAL sets the angle by image projection. The pilot places and keeps (by flying) the images at the level of a runway aiming point, thus the angle also becomes the approach path. Flight control surfaces and throttle are necessary. Engine control instruments are not part of this invention. The pilot views the small mirror, FIG. 8 SIMULATION, to monitor PITCH by keeping the ball of the little “cartoon-like” aircraft at or near the level mark thus assuring the desired aircraft attitude.

An observation principle of flying follows: During flight, if the attitude of a plane is kept at or near level and the throttle is adjusted to keep the craft at a selected altitude, the plane will not stall and a 0° (level) pattern will be flown. The same principle holds true for flying a 3° approach pattem. Rather than flying at the same altitude less throttle is used causing the craft to descend. This descent is controlled by elevator and throttle adjustment so that the aircraft maintains the 3° approach path while still keeping a near level attitude. Again, stall does not loom as a danger. In strong headwinds the nose of the craft is lowered and more throttle is used to maintain the 3° approach path. With no, or mild, tail wind, a level or slightly nose up attitude can be employed as long as the approach angle is flown with a near level attitude. Flap or trim settings are not considered part of this invention or method. The invention, OPAL, includes not only each of it's 6 major parts achieving it's own function but the method of using these functions in a conjoined system for accomplishing the task of flying a safe approach path on VFR.

I firmly and steadfastly believe that 1, Bland Hugh Schwarting, am the sole inventor of OPAL. My searches (see BACKGROUND) have not resulted in any other devices, patented or otherwise, that are similar in design or function of my invention with the exception of two items: Item 1, “Flashlight Glasses,” is or was available on E-bay, Copyright 1986, U.S. Patent #D269125. Although the demonstration model incorporates some information from PATENT #D269125, there are no related referenced claims by OPAL. Item 2, named “Blinky,” is used in one demonstration model. Again, there are no referenced claims. OPAL uses only the words “lights” and “location,” see CLAIMS, p.9, below. My invention embodies a completely new system for providing a safe approach path on VFR. It is a novel “reflect and project system” which generates the approach path from the cockpit. OPAL has 3 claims which follow next, page 9. Since CLAIMS are considered as part of SPECIFICATION and/but also as a separate section, CLAIMS follow on a separate physical page below as required by the USPTO.

1. A unique process of visually projecting (superimposing) images of lights (which have been reflected from a pendular, gravity oriented, magnetically stabilized, transparent, flat or curved plate) onto the view of a runway to indicate the selected approach path on VFR

2. The accomplishment of #1 with mentioned and/or other devices which are totally and only located within the cockpit or immediate vicinity of the landing aircraft

3. Defined location (3 parts) of 2 lights to be reflected in claim #1
3a—as close to the pilot's head sideways as practical without blocking the pencils of light which are reflected from the PLATE to the pilot's eyes
3b—on level with the pilot's eyes up and down as practical with the pilot's head in it's usual flying position
3c*—at a position fore and aft that if a pilot viewed the lights in a flat, vertical, wall mirror approximately 20″ from the eyes, a mild tilting of his head forward or backward would result in no (or insignificant) visible up or down motion of the lights as compared to objects (same level as images) viewed on an opposing wall 10′ or more behind him.
The most critical location (3c) of the three as it functions to steady (hold fast) the vertical approach angle at, e.g. 3°
